(19) United States
(12) Patent Application Publication
(10) Pub. No.: US 2012/0165999 A1
(43) Pub. Date: Jun. 28, 2012

(54) SETTING LOCK AND UNLOCK FUNCTION IN HYDRAULIC HEATING SYSTEMS

(75) Inventors: Zhongjian CHENG, Wilmington, DE (US); Guangyu Mo, Wilmington, DE (US)

(73) Assignee: AHI Technologies, LLC, Wilmington, DE (US)

(21) Appl. No.: 13/335,066

(22) Filed: Dec. 22, 2011

Related U.S. Application Data
(60) Provisional application No. 61/426,655, filed on Dec. 23, 2010.

(51) Int. Cl. G05D 23/00; F24H 1/10; F24H 9/20

(52) U.S. Cl. 700/286; 236/21 B; 392/465

(57) ABSTRACT

A hydraulic heating apparatus is provided having a power control system and a power supply electrically coupled to the power control system. One or more heating elements are electrically coupled to the power control system. A first sensor is electrically coupled to the power control system for measuring incoming water temperature. A second sensor electrically is coupled to the power control system for measuring outgoing water temperature from the heating system. A third sensor is electrically coupled to the power control system for measuring incoming water flow to the heating system. The power consumption of the heating apparatus is managed by the data collected and analyzed from the sensors by a central processing unit and a preset temperature inputted by a user interface circuit. A locking and unlocking function is implemented for preventing unauthorized access and adjusting a prescribed output water temperature of the hydraulic heating apparatus.

### TECHNICAL FIELD

The invention relates generally to hydraulic heating systems and, more particularly, to an apparatus and method for controlling temperature and managing power of heating systems.

### BACKGROUND OF THE INVENTION

Tankless water heaters have been developed in recent years and are known by a variety of names, including instantaneous, combination or “combi” boilers, continuous flow, inline, flash, or on-demand water heaters. This type of water heater is gaining in popularity mainly for space-saving and energy efficiency reasons. These advantages are achieved by heating water as it flows through the unit. This can create cost savings by not having to maintain heated water when it is not in use as is done with tank-type water heaters.

As a practical matter, tankless water heaters may be installed throughout a household at various points-of-use (POU) or at a centralized location. They also can be used alone or in combination with a centrally located water heater. In some cases, larger tankless models may be used to provide the hot water requirements, for example, in an entire house. Whether installed at one or multiple POUs, tankless water heaters provide a continuous flow of hot water and energy savings compared with tank-type heaters, which are only able to provide a finite supply of hot water limited by tank size and hot water recovery rates.

Tankless water heaters can generate a high amount of kilowatt (kw) energy to achieve desired water temperature(s). High kilowatt electric water heaters have the advantage(s) of achieving high energy efficiencies, saving energy consumption and saving space. However, a problem may exist in some high kilowatt electric water heaters in that they can achieve outlet water temperatures up to and above scalding water temperatures. In some instances, even when the temperature setting of the high kilowatt electric water heater is set below scalding water temperature, the setting may be modified if not made inaccessible to unauthorized personnel. Thus, without having a lock function or a means to block undesired personnel from adjusting the output water temperature, the tankless water heater equipment can pose a danger to users.

In some conventional tankless water heater systems, attempts have been made to address one or more of the aforementioned problems. Such attempts have included utilizing a box that has a physical lock to enclose the water heater inside the box for preventing unauthorized change in temperature set. However, this approach can increase the installation complexity and cost. In addition, it is not always possible to add a box-type construction due to constraints on available working space.

However, there still remains a need in the art to provide a more efficient and effective tankless water heating apparatus and method for setting a lock and unlock function in hydraulic heating systems.

The present disclosure is directed towards overcoming one or more shortcomings set forth above.

### SUMMARY OF THE INVENTION

It is, therefore, one object of the present invention to overcome the deficiencies of the prior art and by providing an apparatus and method for locking and unlocking the temperature setting of hydraulic heating equipment. In addition, the apparatus and method may prevent unauthorized change on the temperature setting while still allowing authorized personnel to change the temperature setting as needed. In some disclosed embodiments, the invention may provide hardware or a combination of hardware and software to implement the lock and unlock function.

### BRIEF DESCRIPTION OF THE DRAWINGS

FIG. 1 is a schematic internal illustration of a water heating system according to an exemplary disclosed embodiment.

### DETAILED DESCRIPTION OF THE INVENTION

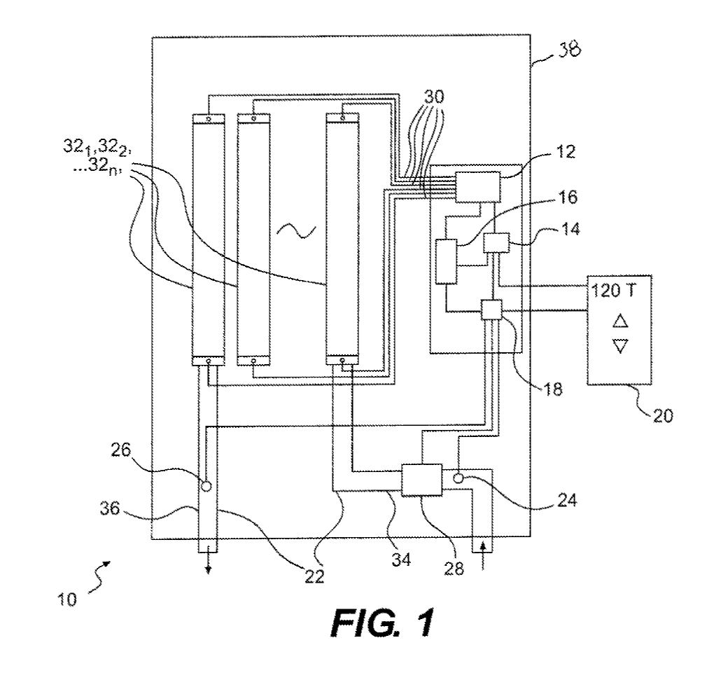

The invention will now be described with reference to the drawing figures, in which like reference numerals refer to like parts throughout. Referring to FIG. 1, an embodiment of a hydraulic heating system or water heating system 10 is provided illustrating internal components therein. For illustrative and discussion purposes, the present embodiment of the water heating system 10 is represented as a tankless water heater configuration. However, the invention is not limited to a tankless water heater configuration and may be applied to any variety of water heaters, boilers, and other hydraulic heating systems.

The water heating system 10 includes a control system that manages power consumption of the water heater in order to accurately control output water temperature at a desired temperature level. Embodiments of the invention allow the water heating system 10 to more readily maintain a constant water temperature with or without changes in water flow. In addition the water heating system 10, of the described invention, also enables a desired water temperature to be achieved and maintained more quickly and accurately by use of the configuration of elements/components as described below.

A master control electric circuit 16 is provided and may be electrically connected to various components within the water heating system 10 such as via internally connected electric wires 30. Master control electric circuit 16 or power management circuit may include a logical circuitry configuration containing one or more combination of electrical components including, for example, TRIACs (silicon-controlled rectifier), relay(s), or a combination thereof. The amount and specification of electronic components is appropriately selected, at least, based upon the size of heating elements and/or heating requirements of the water heating system 10.

The power control system of water heating system 10 preferably includes an AC power supply 12 and a direct-current and AC power supply exchange circuit 14. Both the AC power supply 12 and a direct-current and AC power supply exchange circuit 14 are electrically connected to the master control electric circuit 16. One or more heating elements (32₁, 32₂ . . . 32ₙ) may be provided for heating water supplied to each one of the heating elements. The one or more heating elements (32₁, 32₂ . . . 32ₙ) may be arranged relative to the flow direction of water. Multiple heating elements may be arranged in serial, parallel, or a combination of serial and parallel connection-type configurations. Each heating element is electrically connected to and controlled by a master control electric circuit 16. Thus, the amount of power supplied to one or more heating elements (32₁, 32₂ . . . 32ₙ) is supplied by the AC power supply 12 and regulated by the master control electric circuit 16. The power requirements of the water heating system 10 may increase gradually up to and including reaching the maximum power depending on the system requirements as discussed below.

In one preferred embodiment, central processing unit (CPU) 18 is provided and electrically connected to master control electric circuit 16. A user operation interface circuit 20 is also provided and electrically coupled to the master control electric circuit 16 and CPU 18. In some disclosed embodiments, the user operation interface circuit 20 may be configured to allow a user to manually set and/or adjust a prescribed temperature of the water heating system 10 at a desired level.

The water heating system 10 may be configured to receive and output water such as via pipes 22 coupled thereto. Thus, in one embodiment, an inlet water pipe 34 is provided to supply water to the water heating system 10. Water pipe 34 may be constructed of metal or non-metal material. Water flow sensor 28 is provided to measure water flow into the water heating system 10. An incoming water temperature sensor 24 may be utilized to measure the incoming water temperature of the water heating system 10. Each of the water flow sensor 28 and the incoming water temperature sensor 24 may be electrically connected to the CPU 18.

Outlet water pipe 36 may be provided to transfer water from the water heating system 10 to one or multiple POUs. Water pipe 36 may be constructed of metal or non-metal material. The disclosed embodiment preferably provides an output water temperature sensor 26 to measure the temperature of the output water. The output water temperature sensor 26 may also be electrically coupled to the CPU 18.

Thus, unlike some conventional tankless water heater systems which may merely provide a limited number of components (such as an output water temperature sensor and flow switch, or a combination of an output water temperature sensor, flow switch, and incoming water temperature sensor), the presently described invention also employs the water flow sensor 28 to facilitate achieving and maintaining a constant water temperature for a user. By monitoring the water flow into water heating system 10, the described invention will more readily maintain a constant water temperature with or without changes in water flow. In addition water heating system 10 also enables a desired water temperature to be achieved and maintained more quickly and accurately by use of the water flow sensor 28 in combination with the additional components described herein.

The CPU 18 regulates the master control electric circuit 16 by analyzing and calculating the data collected through various components of the water heating system 10. This allows the CPU 18 to manage power consumption via the master control electric circuit 16 by analyzing the combined data collected from the incoming water temperature sensor 24, the output water temperature sensor 26, the water flow sensor 28, and the desired temperature set by the user via the user operation interface circuit 20. Upon doing so, the CPU 18 controls and adjusts the AC power supply 12 to supply increased or decreased power, as needed.

In operation, a user sets the desired water temperature for the heating system 10 via user operation interface circuit 20. The user operation interface circuit 20 may include any electronic and/or mechanical components (e.g., keypad) appropriately configured to allow a user to enter electrical information into the water heating system 10. The user operation interface circuit 20 may also include a display device (e.g., monitor) for interacting with the user during operation. The water heating system 10 is electrically configured to monitor the incoming water temperature (via sensor 24), the output water temperature (via sensor 26), the incoming water flow (via sensor 28), and the desired temperature set by the user (via user operation interface circuit 20).

The water heating system 10 is configured to provide an amount of power (e.g., via the CPU 18) to the water heating system 10 based upon an amount of water flowing through the system and a desired temperature of the output water set by a user. The power requirement is used to heat the water flowing through the water heating system 10 to achieve and maintain the desired water temperature set by the user. If the water flow varies into the water heating system 10, the system automatically adjusts the power (e.g., via the CPU 18) as necessary to maintain the desired output water temperature.

The amount of power required by water heating system 10 to achieve a desired output water temperature is determined, inter alia, by measuring the difference in temperature between the incoming water temperature and the temperature set by the user. The water heating system 10 will also measure an output temperature of the output water. If the output temperature is more or less than a preset value range from the temperature set by the user, the water heating system 10 will adjust its power output required to achieve the temperature set by the user based on the water flow (i.e., the amount of water to be heated) and the temperature difference between the incoming water temperature and the temperature set by the user. In one embodiment, the aforementioned value range may be set, for example, at 2 degrees F. +/− from the temperature set by the user.

A checking function of the water heating system 10 may be employed to ensure the heating system is accurately achieving and maintaining the temperature set by the user within a prescribed amount of time. For example, in one embodiment, the checking function of water heating system 10 may be configured to occur multiple times per second. In another embodiment, the checking function of water heating system 10 may be configured to occur multiple times over a period of multiple seconds. Thus, given the above exemplary preset value range of 2 degrees F. +/− from the temperature set by the user, the water heating system 10 is configured to check multiple times over a prescribed period of time whether the water output temperature is within +/−2 degrees F. from the temperature set by the user.

An advantage of the present invention includes a means to lock and unlock the temperature setting of the output water temperature. Additional embodiments provide features for preventing unauthorized modification to the locked temperature setting and provisions for only allowing authorized personnel to change and/or modify the temperature settings as needed. The described invention may include a control mechanism for hydraulic heating equipment used for space heating or domestic water heating environments. Features for unlocking and locking the output water temperature setting may include the described hardware and one or a combination of software implementations. The lock and unlock function of water heating system 10 may be configured to control the output water temperature such as by controlling the power generated by the system and/or the length of time the output water temperature is provided.

In one disclosed embodiment, components of water heating system 10 may be encased within exterior covering 38. The exterior covering 38 may a limited access-type casing (e.g., lockable-type key entry, electronically programmable entry-type, combination lock-type, etc.) suitable for preventing unauthorized access to its interior components. The master control electric circuit 16 may include a control element such as an electric switch or knob configured to set a prescribed output water temperature setting, for example, by changing the position of the electric switch or knob hardware. Thus, set parameters of the output water temperature may be related to the position of the control element, (e.g., electric switch or knob), thereby enabling a user to establish and set a locked output water temperature setting.

This aforementioned locked output water temperature setting may also be established as a maximum output water temperature setting. Thus, if a desired temperature is attempted to be set by a user, such as via equipment controls disposed exterior to the limited access-type casing, the maximum output water temperature setting is configured to override any value past its set output water temperature setting. By way of example, the aforementioned exterior equipment controls may include user operation interface circuit 20. In this manner, a user may be prevented from raising the output water temperature possibly to a dangerous level beyond the prescribed maximum water temperature setting of the water heating system 10. This acts as an additional security/safety function if, for example, the output water temperature sensor 26 fails.

For example, a user may program the prescribed temperature of the water heating system 10 to generate output water at 100-110° F. The maximum water temperature setting of the water heating system 10 may be established and set, for example, at 120° F., for example, in a residential application. If an event occurs, such that output water temperature sensor 26 fails, the water heating system 10 may otherwise continue to produce output water at temperatures above 110° F. However, the safety feature of the present invention prevents unlimited surging output water temperatures, because, in this case, the maximum output water temperature setting that the water heating system 10 can produce is 120° F. Of course, the aforementioned example is for illustrative purpose(s) only; other prescribed temperature settings and maximum output water temperature settings (e.g., 110° F., for commercial applications and 180° F., for commercial booster applications) may be established and produced by the water heating system 10 of the present invention. Hence, the versatility of the presently disclosed invention may be readily appreciated by those skilled in the art.

In another embodiment, components of the master control electric circuit may include a digital controller configured and utilized with components of the water heating system 10 to program a maximum output water temperature setting. The digital controller may be utilized in combination with CPU 18 to calculate the amount of power (kilowatts) needed to generate the maximum output water temperature setting. Elements of the disclosed embodiment may include a software implementation for programming the water heating system 10. Hardware components, such as the user operation interface circuit 20, may be enabled to allow the water heating system 10 to enter a programming mode. For example, the user operation interface circuit 20 may include a keypad configurable to allow the water heating system 10 to enter a programming mode. In one embodiment, a combination of keys may be held for a fixed time period in order to enter the programming mode. In another embodiment, a sequential entering of keys on the keypad may trigger the programming mode. Other alternative methods and hardware may be employed for triggering programming of the water heating system 10 to establish a maximum output water temperature setting.

Upon the software recognizing that the programming mode has been enacted, an authorized user may program and set the output water temperature setting of the water heating system 10. The hardware and software may also be configured to deactivate the setting function of the water heating system 10, once the output water temperature has been programmed. Again, the user operation interface circuit 20 may be electronically configured to activate and deactivate the water heating system 10 to enter and set the output water temperature setting. This output water temperature setting may be established to be non-changeable value unless the water heating system 10 detects another signal for entering the programming mode (e.g., same combination of keys held for fixed time period or preset sequential entering of keys on the keypad). In this manner, unless one readily knows how to place the user operation interface circuit 20 in programming mode, unauthorized persons are not able to configure, set or reset the output water temperature setting. As with previous embodiments, the output water temperature setting, established by the user operation interface circuit 20 in programming mode, may also be established as a maximum output water temperature setting. The maximum output water temperature setting may be set to override a desired higher temperature setting. This may occur, for example, when the water heating system 10 is operated by a user (such as via the user interface circuit 20) to set an output water temperature when the water heating system 10 is not in programming mode.

In operation, the incoming water flow sensor 28 and incoming water temperature sensor 24 may measure the flow data and temperature data from the incoming water of the water heating system 10. CPU 18 may process this information against the preset output water temperature condition of the digital controller and the sensor information provided by the output water temperature sensor 26. The power setting of the water heating system 10 is automatically adjusted by calculating the kilowatts needed to generate the prescribed output water temperature. For example, if the incoming water temperature is too high (e.g., summer time environment) or too low (e.g., winter time conditions), the water heating system 10 can automatically adjust the unit by calculating the necessary kilowatts needed to establish or maintain a prescribed output water temperature.

Thus, the disclosed invention provides a simplified electronic circuit structure while accurately managing the power needed to control output water temperature. It will be apparent to those skilled in the art that various modifications and variations can be made in the disclosed apparatus and method without departing from the scope of the disclosure. For example, while embodiments are described applicable to tankless water heaters, the system, described herein, may be employed in not only high efficiency electric water heaters, but also to additional systems including, for example, boilers and other residential, commercial, or industrial hydraulic heating systems. While a user operation interface circuit 20 has been described to program the water heating system 10, other devices and technology may be implemented for programming the same include, for example, radio frequency transmission and remotely controlled signals.

Additionally, other embodiments of the apparatus and method will be apparent to those skilled in the art from consideration of the specification. It is intended that the specification and examples be considered as exemplary only, with a true scope of the disclosure being indicated by the following claims and their equivalents.

1. A fluid heating system comprising:
a heating system for receiving fluid, heating the fluid, and outputting the fluid;
one or more fluid temperature and flow sensors for detecting the temperature and flow rate of the fluid at one or more locations within the fluid heating system;
a user interface for setting a desired temperature of the fluid;
a processor electrically connected to the one or more fluid temperature and flow sensors, the user interface and the heating system, wherein the processor receives information from the one or more fluid temperature and flow sensors, the user interface and the heating system, manages power to the heating system and regulates the temperature of the fluid based on the information; and
a locking and unlocking system for setting or changing a maximum temperature of the fluid,
wherein the processor prevents an actual temperature of the fluid from exceeding the maximum temperature of the fluid regardless of the desired temperature of the fluid.

2. A water heating system comprising:
a water inlet connected to one or more heating elements via a first pipe;
a water outlet connected to the one or more heating elements via a second pipe;
an inlet water temperature sensor attached to the first pipe between the water inlet and the one or more heating elements;
a water flow sensor attached to the first pipe between the water inlet and the one or more heating elements;
an output water temperature sensor attached to the second pipe between the one or more heating elements;
a central processing unit electrically connected to the inlet water temperature sensor, the water flow sensor, and the output water temperature sensor;
a master control electric circuit, a direct-current and alternating-current power supply exchange circuit and a user operation interface circuit electrically connected to the central processing unit, wherein the direct-current and alternating-current power supply exchange circuit is electrically connected to the master control electric circuit and the user operation interface circuit;
an alternating-current power supply electrically connected to the master control electric circuit and the direct-current and alternating-current power supply exchange circuit, wherein the alternating-current power supply is electrically connected to the one or more heating elements; and
an exterior covering, wherein the one or more heating elements, a portion of the first pipe, a portion of the second pipe, the inlet water temperature sensor, the water flow sensor, the output water temperature sensor, the central processing unit, the master control electric circuit, the direct-current and alternating-current power supply exchange circuit and the alternating-current power supply are provided inside of the exterior covering, and wherein the water inlet, the user operation interface circuit and the water outlet are provided outside of the exterior covering.

3. The water heating system of claim 2, wherein the user operation interface circuit is configured to allow a user to manually set and/or adjust a prescribed temperature of the water heating system at a desired level.

4. The water heating system of claim 2, wherein the central processing unit manages power consumption via the master control electric circuit by analyzing combined data collected from the inlet water temperature sensor, the output water temperature sensor, the water flow sensor, and the desired temperature set by the user via the user operation interface circuit.

5. The water heating system of claim 2, wherein the central processing unit adjusts the alternating-current power supply to supply increased or decreased power depending on the combined data collected from the inlet water temperature sensor, the output water temperature sensor, the water flow sensor, and the desired temperature set by the user via the user operation interface circuit.

6. The water heating system of claim 2, wherein the water heating system is electrically configured to monitor an incoming water temperature via the inlet water temperature sensor, an output water temperature via the output water temperature sensor, an incoming water flow via water flow sensor, and the desired temperature set by the user via the user operation interface circuit.

7. The water heating system of claim 2, wherein, if water flow varies into the water heating system, the water heating system automatically adjusts power via the central processing unit to maintain a desired output water temperature.

8. The water heating system of claim 2, wherein the amount of power required by the water heating system to achieve a desired output water temperature is determined by measuring a difference in temperature between the incoming water temperature and the temperature set by the user.

9. The water heating system of claim 2, wherein, if the output temperature is more or less than a preset value range from the temperature set by the user, the water heating system adjusts the power output required to achieve the temperature set by the user based on the water flow and the temperature difference between the incoming water temperature and the temperature set by the user.

10. The water heating system of claim 2, wherein the output temperature is checked and adjusted as needed multiple times per second or multiple times over a period of multiple seconds.

11. The water heating system of claim 2, wherein the water heating system comprises a means to lock and unlock the temperature setting of the output water temperature.

12. The water heating system of claim 11, wherein the water heating system comprises a means for preventing unauthorized modification to the locked temperature setting and means for only allowing authorized personnel to change and/or modify the temperature settings.

13. The water heating system of claim 2, wherein the exterior covering is suitable for preventing unauthorized access to its interior components.

14. The water heating system of claim 2, wherein the master control electric circuit includes a control element configured to set a prescribed output water temperature setting thereby enabling a user to establish and set a locked output water temperature setting.

15. The water heating system of claim 2, wherein the maximum output water temperature is not affected in the event of the failure of the output water temperature sensor.

16. The water heating system of claim 2, wherein the incoming water flow sensor and incoming water temperature sensor measure flow data and temperature data from the incoming water of the water heating system.

17. The water heating system of claim 2, wherein the central processing unit compares the flow data and temperature data with a preset output water temperature condition of the digital controller and the sensor information provided by the output water temperature sensor.

18. The water heating system of claim 2, wherein a power setting of the water heating system is automatically adjusted by calculating the power needed to generate a prescribed output water temperature.

19. The water heating system of claim 2, wherein the user operation interface circuit allows the water heating system to enter a programming mode.

20. A method of heating a fluid using a fluid heating system, the method comprising:
inputting the fluid into the fluid heating system;
detecting a temperature and flow rate of the fluid at one or more locations within the fluid heating system using one or more fluid temperature and flow sensors;
setting a desired temperature of the fluid using a user interface;
processing information from the one or more fluid temperature and flow sensors, the user interface and the heating system, managing power to the heating system and regulating the temperature of the fluid based on the information using a processor;
setting or changing a maximum temperature of the fluid using a locking and unlocking system,
heating the fluid to the desired temperature if the desired temperature is less than or equal to the maximum temperature and heating the fluid to the maximum temperature if the desired temperature is greater than the maximum temperature;
preventing an actual temperature of the fluid from exceeding the maximum temperature of the fluid regardless of the desired temperature of the fluid; and
outputting the fluid from the fluid heating system.
